(19) United States
(12) Patent Application Publication
(10) Pub. No.: US 2026/0195241 A1
(43) Pub. Date: Jul. 9, 2026

(54) BREAKPOINT MANAGEMENT AND EXECUTION ENGINE IN DISTRIBUTED CLOUD SYSTEMS

(71) Applicant: FAIR ISAAC CORPORATION, Minneapolis, MN (US)

(72) Inventors: Balachandar RS, Bangalore (IN); Imran Ali, Bangalore (IN); Keith Berkland, Boulder, CO (US); Priya Yadav, Uttar Pradesh (IN)

(21) Appl. No.: 19/015,169

(22) Filed: Jan. 9, 2025

(51) Int. Cl. G06F 11/362; G06F 11/32

(52) U.S. Cl. CPC G06F 11/3644; G06F 11/323

(57) ABSTRACT

A method for identifying logical mistakes in a cloud-based decision management system, comprising, providing an interface configured to present decision logic using a structured rule language; defining a plurality of functional breakpoints within the structured rule language; pausing execution of the decision logic at one or more of the plurality of functional breakpoints to allow inspection of underlying logic and associated data changes, wherein the pausing and synchronization are facilitated by a distributed breakpoint execution engine operating within the cloud-based decision management system; providing a visualization of a plurality of parameters through a properties tab; and resuming the execution of the decision logic to facilitate identification of the logical mistakes in the decision logic, wherein the visualization provides real-time updates and aids in pinpointing logical mistakes.

### TECHNICAL FIELD

The subject matter described herein relates to cloud computing technology, specifically systems and methods for real-time debugging, breakpoint management, and distributed execution of structured rule logic in cloud-based environments.

### BACKGROUND

In modern cloud computing environments, particularly those supporting industries like healthcare, logistics, and industrial automation, the ability to design, debug, and maintain decision logic efficiently is critical for ensuring system reliability and accuracy. Decision logic often governs important processes such as patient treatment workflows, inventory management, and automated quality control. These systems are typically managed through rule-based platforms or decision engines that translate complex operational logic into structured rules. However, debugging and maintaining such logic, especially when errors occur, can be cumbersome and resource-intensive.

Current debugging methodologies in cloud-based rule management systems are frequently limited in their ability to provide precise, real-time insights into decision logic execution. These methods often rely on post-execution analysis, where users manually trace logic flows and inspect outputs without a dynamic or interactive mechanism for identifying errors during execution. Additionally, traditional debugging systems typically lack the capability to handle large-scale, distributed rule processing efficiently, leading to challenges in managing computational resources, ensuring data consistency, and synchronizing across cloud nodes.

The absence of robust debugging tools further complicates the management of complex, nested decision logic. Existing systems provide minimal support for setting breakpoints at various functional or granular levels within the rule logic, making it difficult to isolate and address logical errors effectively. This limitation is especially problematic in large-scale rule-based projects, where thousands of interdependent rules need to be validated and corrected in real time. These inefficiencies can lead to prolonged debugging cycles, increased operational costs, and reduced system reliability.

There is a need for advanced debugging solutions tailored to cloud-based decision management systems that can address the challenges of real-time rule execution, distributed processing, and interactive error identification. Such a system would provide dynamic debugging capabilities, optimize computational resource usage, and enable users to identify and resolve logical errors efficiently.

### SUMMARY

Methods, systems, and articles of manufacture, including computer program products, are provided for a method for identifying logical mistakes in a cloud-based decision management system, wherein the method comprises providing an interface configured to present decision logic using a structured rule language; defining a plurality of functional breakpoints within the structured rule language, wherein the plurality of functional breakpoints is managed by a breakpoint management module configured to optimize computational power and memory utilization across distributed cloud nodes of the cloud-based decision management system; pausing execution of the decision logic at one or more of the plurality of functional breakpoints to allow inspection of underlying logic and associated data changes, wherein the pausing and synchronization are facilitated by a breakpoint execution engine operating within the cloud-based decision management system; providing a visualization of a plurality of parameters through a properties tab, wherein the visualization is dynamically processed in real-time by a visualization processing module using distributed caching and synchronization of the cloud-based decision management system, wherein the visualization processing module collaborates with the breakpoint management module to optimize computational power by selectively updating parameters that are relevant to the functional breakpoint, and dynamically allocating lightweight cloud nodes for visualization tasks; and resuming the execution of the decision logic to facilitate identification of the logical mistakes in the decision logic, wherein the visualization provides real-time updates and aids in pinpointing logical mistakes, and wherein the breakpoint management module deploys one or more of the plurality of functional breakpoints based at least in part on computational resource.

In some variations, the method further comprises enabling a user to define one or more line breakpoints within a selected function breakpoint; and allowing the user to navigate the decision logic by stepping over or stepping into individual lines or nested functionals using one or more navigation commands associated with the one or more line breakpoints.

In some variations, the navigation commands comprise a first command to execute the logic one line at a time without entering nested functionals; and a second command to enter the logic of a nested functional.

In some variations, the functional breakpoints and line breakpoints are represented visually in an editor window of the structured rule language to allow the user to interactively select, modify, or remove breakpoints.

In some variations, the properties tab comprises: i) a parameters node configured to display values of input parameters; ii) a global variables node configured to display values of global variables, and iii) a local variables node configured to display values of local variables.

In some variations, the method further comprises providing a console tab that displays results of print statements embedded in the structured rule language, wherein the displayed results are updated as the execution progresses.

In another aspect, there is provided a computer program product for identifying logical mistakes in a cloud-based decision management system. The computer program product includes a non-transitory computer readable medium storing instructions that, when executed by at least one programmable processor, cause the at least one programmable processor to perform operations. The operations include providing an interface configured to present decision logic using a structured rule language; defining a plurality of functional breakpoints within the structured rule language, wherein the plurality of functional breakpoints is managed by a breakpoint management module configured to optimize computational power and memory utilization across distributed cloud nodes of the cloud-based decision management system; pausing execution of the decision logic at one or more of the plurality of functional breakpoints to allow inspection of underlying logic and associated data changes, wherein the pausing and synchronization are facilitated by a breakpoint execution engine operating within the cloud-based decision management system; providing a visualization of a plurality of parameters through a properties tab, wherein the visualization is dynamically processed in real-time by a visualization processing module using distributed caching and synchronization of the cloud-based decision management system, wherein the visualization processing module collaborates with the breakpoint management module to optimize computational power by selectively updating parameters that are relevant to the functional breakpoint, and dynamically allocating lightweight cloud nodes for visualization tasks; and resuming the execution of the decision logic to facilitate identification of the logical mistakes in the decision logic, wherein the visualization provides real-time updates and aids in pinpointing logical mistakes, and wherein the breakpoint management module deploys one or more of the plurality of functional breakpoints based at least in part on computational resource.

In some variations, the method further comprises enabling a user to define one or more line breakpoints within a selected function breakpoint; and allowing the user to navigate the decision logic by stepping over or stepping into individual lines or nested functionals using one or more navigation commands associated with the one or more line breakpoints.

In some variations, the navigation commands comprise a first command to execute the logic one line at a time without entering nested functionals; and a second command to enter the logic of a nested functional.

In some variations, the functional breakpoints and line breakpoints are represented visually in an editor window of the structured rule language to allow the user to interactively select, modify, or remove breakpoints.

In some variations, the properties tab comprises: i) a parameters node configured to display values of input parameters; ii) a global variables node configured to display values of global variables, and iii) a local variables node configured to display values of local variables.

In some variations, the method further comprises providing a console tab that displays results of print statements embedded in the structured rule language, wherein the displayed results are updated as the execution progresses.

In another aspect, there is provided a system for identifying logical mistakes in a cloud-based decision management system. The system includes: a programmable processor; and a non-transient machine-readable medium storing instructions that, when executed by the processor, cause the at least one programmable processor to perform operations. The operations include: include providing an interface configured to present decision logic using a structured rule language; defining a plurality of functional breakpoints within the structured rule language, wherein the plurality of functional breakpoints is managed by a breakpoint management module configured to optimize computational power and memory utilization across distributed cloud nodes of the cloud-based decision management system; pausing execution of the decision logic at one or more of the plurality of functional breakpoints to allow inspection of underlying logic and associated data changes, wherein the pausing and synchronization are facilitated by a breakpoint execution engine operating within the cloud-based decision management system; providing a visualization of a plurality of parameters through a properties tab, wherein the visualization is dynamically processed in real-time by a visualization processing module using distributed caching and synchronization of the cloud-based decision management system, wherein the visualization processing module collaborates with the breakpoint management module to optimize computational power by selectively updating parameters that are relevant to the functional breakpoint, and dynamically allocating lightweight cloud nodes for visualization tasks; and resuming the execution of the decision logic to facilitate identification of the logical mistakes in the decision logic, wherein the visualization provides real-time updates and aids in pinpointing logical mistakes, and wherein the breakpoint management module deploys one or more of the plurality of functional breakpoints based at least in part on computational resource.

In some variations, the method further comprises enabling a user to define one or more line breakpoints within a selected function breakpoint; and allowing the user to navigate the decision logic by stepping over or stepping into individual lines or nested functionals using one or more navigation commands associated with the one or more line breakpoints.

In some variations, the navigation commands comprise a first command to execute the logic one line at a time without entering nested functionals; and a second command to enter the logic of a nested functional.

In some variations, the functional breakpoints and line breakpoints are represented visually in an editor window of the structured rule language to allow the user to interactively select, modify, or remove breakpoints.

In some variations, the properties tab comprises: i) a parameters node configured to display values of input parameters; ii) a global variables node configured to display values of global variables, and iii) a local variables node configured to display values of local variables.

In some variations, the method further comprises providing a console tab that displays results of print statements embedded in the structured rule language, wherein the displayed results are updated as the execution progresses.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an exemplary architecture of a cloud-based debugging system, in accordance with one or more embodiments of the current subject matter.

FIG. 2 is a diagram illustrating an example of an internal structure of the breakpoint management module, in accordance with one or more embodiments.

FIG. 3 is a diagram illustrating an example of an internal structure of the visualization processing module, in accordance with one or more embodiments.

FIG. 4 is a diagram illustrating a flow chart of a process 400 for identifying logical mistakes in a cloud-based decision management system, in accordance with one or more embodiments of the current subject matter.

FIG. 5 depicts a block diagram illustrating a computing system consistent with implementations of the current subject matter.

When practical, like labels are used to refer to same or similar items in the drawings.

### DETAILED DESCRIPTION

The details of one or more variations of the subject matter described herein are set forth in the accompanying drawings.

Recognizing the limitations of existing systems as described above, the present disclosure provides systems and methods that address these challenges by introducing approaches to debugging decision logic in cloud-based environments. In some embodiments, these approaches include mechanisms for dynamic breakpoint management, real-time data visualization, and distributed execution synchronization, which together enhance the efficiency and scalability of debugging workflows. In some embodiments, decision logic refers to a structured representation of conditional and computational rules that guide automated decision-making processes within a system. For example, it comprises the conditions, actions, and sequences of operations that determine how a system responds to various inputs or scenarios. Decision logic is typically implemented in domains like business workflows, rule-based engines, and automation systems, enabling consistent, repeatable, and transparent decision-making. Examples include business rule management systems (BRMS), decision tables, and if-then-else constructs. Structured rule language is a formalized, syntax-driven language designed to define, manage, and execute decision logic in a clear and interpretable manner. It provides a standardized framework for expressing complex conditional logic, rules, and operations in a machine-readable format. Structured rule languages are often used in rule-based systems and decision management platforms to facilitate modularity, scalability, and maintainability of rules. Examples include Drools Rule Language (DRL), Decision Model and Notation (DMN), and custom domain-specific languages tailored for specific use cases.

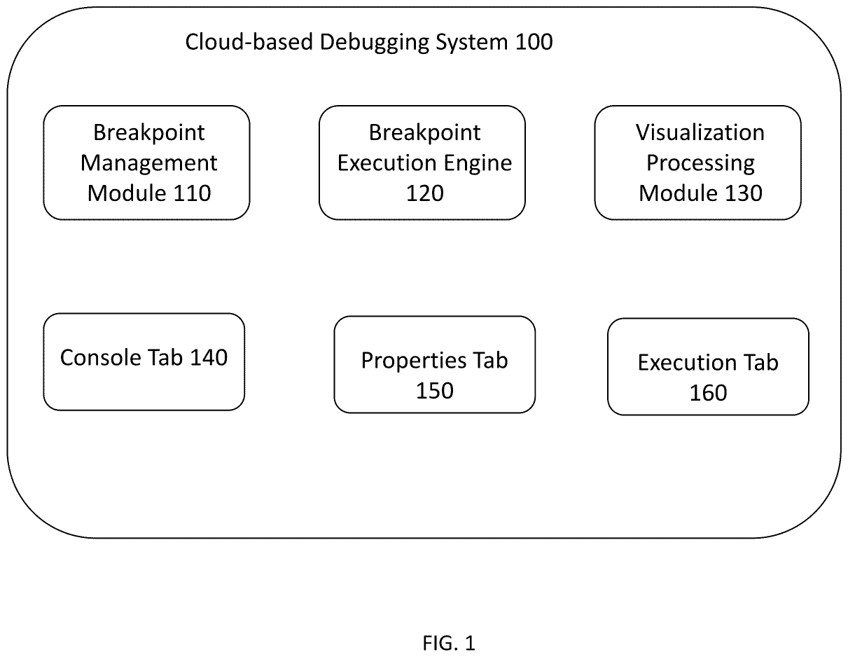

FIG. 1 is a diagram illustrating an exemplary architecture of a cloud-based debugging system 100, which facilitates the debugging of decision logic through distributed modules and interactive user interfaces. The system 100 includes several interconnected components. Breakpoint management module 110 is configured to define and manage a plurality of functional and line breakpoints. The breakpoint management module 110, in some embodiments, analyzes computational power and memory utilization across distributed cloud nodes to allocate breakpoints efficiently. The breakpoint management module 110 collaborates with other modules, such as the visualization processing module 130 and the synchronization module (not shown in FIG. 1), to provide optimized computational resource utilization. By dynamically monitoring the available CPU power, memory, and bandwidth of each node, the breakpoint management module 110 prioritizes the deployment of breakpoints on nodes with sufficient capacity (i.e., lightweight nodes) to handle the computational demands and/or visualization tasks. Furthermore, the breakpoint management module 110 minimizes unnecessary resource consumption by selectively updating only the parameters directly relevant to active breakpoints. This selective update strategy reduces processing overhead and enables that computational resources are allocated effectively, for example, during complex debugging workflows involving nested decision logic or interdependent rules. For instance, during the identification of logical mistakes, the breakpoint management module 110 may dynamically reallocate breakpoints to nodes with lighter workloads, thereby maintaining smooth execution and accurate synchronization across the distributed system. In some embodiments, the breakpoint management module 110 dynamically evaluates the computational load associated with active debugging tasks and selectively activates only those breakpoints relevant to the debugging context. For example, during a debugging session focused on identifying errors in nested decision logic, the module may activate breakpoints only for functions and variables directly linked to the suspected error. This selective activation significantly reduces unnecessary computation and minimizes memory overhead, enabling a more efficient allocation of cloud resources. For example, when handling a high-complexity decision logic requiring multiple breakpoints, the module balances their allocation across nodes to avoid bottlenecks and optimize performance. In some embodiments, a function breakpoint may be selected by a user based on specific debugging needs, such as isolating critical decision nodes or frequently failing functions. The selection process can be performed through the interface module (not shown in the FIGs), which presents the available function breakpoints visually in an editor window. For example, a user may select a function breakpoint corresponding to a specific decision node within a ruleset that has shown inconsistent results during previous executions. The interface enables interactive selection by highlighting functions and allowing users to set, modify, or remove function breakpoints dynamically. The selected function breakpoint allows the system to focus debugging efforts on a specific logical scope, enhancing efficiency. In some embodiments, a selected function breakpoint refers to a user-defined breakpoint chosen from multiple available functional breakpoints based on debugging requirements. Selection criteria may include logical complexity, frequency of errors, or data dependencies. For instance, if a specific function in the decision logic frequently produces unexpected results, a user may select it as a function breakpoint to focus debugging efforts. This selection can be performed interactively through the interface module, which visually displays all available functional breakpoints and provides tools for selection, modification, or removal.

Breakpoint execution engine 120 coordinates the execution and pausing of decision logic at the defined breakpoints. It also maintains synchronization across distributed cloud nodes to aid in consistent debugging states. For example, when a breakpoint is triggered on one node, related data across other nodes is synchronized to provide a unified debugging perspective. Visualization processing module 130 processes and updates debugging data dynamically, including states of input parameters, global variables, and local variables. In some embodiments, it uses distributed caching and synchronization techniques to deliver real-time updates, enabling that users receive accurate and current debugging information during execution. In some embodiments, the visualization processing module 130 dynamically updates debugging data, collaboration with the computational resource optimization provided by the breakpoint management module 110. By selectively prioritizing parameters associated with active breakpoints, the breakpoint management module 110 reduces redundant updates and ensures that distributed caching remains lightweight and efficient. For instance, during the debugging of nested decision logic, only the parameters linked to active decision nodes are synchronized across nodes, minimizing latency. To further enhance efficiency, the breakpoint management module 110 identifies and selects lightweight nodes for computationally intensive visualization tasks. These nodes are chosen based on their current resource availability, including CPU usage, memory capacity, and network bandwidth. Nodes with minimal workloads and sufficient processing power are prioritized to ensure smooth execution without overloading the system. Once selected, lightweight nodes are tasked with managing visualization-related computations, such as rendering parameter updates and handling distributed caching operations. This strategy reduces the burden on heavily utilized nodes and ensures consistent debugging performance across the distributed cloud environment. For example, during a high-complexity debugging session, lightweight nodes can dynamically manage the real-time synchronization of input parameters, global variables, and visualization updates while maintaining low latency.

The system 100 also includes three interactive tabs that present debugging data to the user. Console tab 140 is configured to display outputs from print statements embedded within the decision logic, allowing users to monitor the real-time progress of execution and understand intermediate results. Properties tab 150 dynamically displays the current values of input parameters, global variables, and local variables, enabling users to inspect and analyze data for potential logical mistakes. For example, when a user pauses execution at a breakpoint, properties tab 150 may show unexpected parameter values that help pinpoint the cause of an error. Execution tab 160 provides an execution stack that traces the sequence of decision logic executed up to the current breakpoint, enabling users to follow the flow of logic and identify where deviations or errors occur. For example, a user may use execution tab 160 to trace nested function calls and identify the specific function where a condition failed. In some embodiments, users interact with breakpoint management module 110 through an interface to define or modify breakpoints dynamically. When a breakpoint is triggered, breakpoint execution engine 120 pauses execution and collects debugging data, which is then processed by visualization processing module 130 for display across console tab 140, properties tab 150, and execution tab 160. For instance, when execution is paused at a breakpoint, the user can view real-time parameter values in properties tab 150, trace the logic flow through execution tab 160, and check intermediate outputs in console tab 140 to identify the root cause of an issue. The interaction between these modules establishes a seamless debugging workflow where breakpoints are defined, executed, and analyzed iteratively. This architecture supports a dynamic data flow between modules. For example, breakpoint management module 110 allocates breakpoints to appropriate cloud nodes based on resource availability, while breakpoint execution engine 120 monitors and pauses decision logic as necessary. Debugging data generated during execution is processed by visualization processing module 130 and distributed to console tab 140, properties tab 150, and execution tab 160 in real time. This modular and distributed design allows the system to handle large-scale decision logic efficiently, enabling users to debug complex rule sets across multiple cloud nodes with minimal latency.

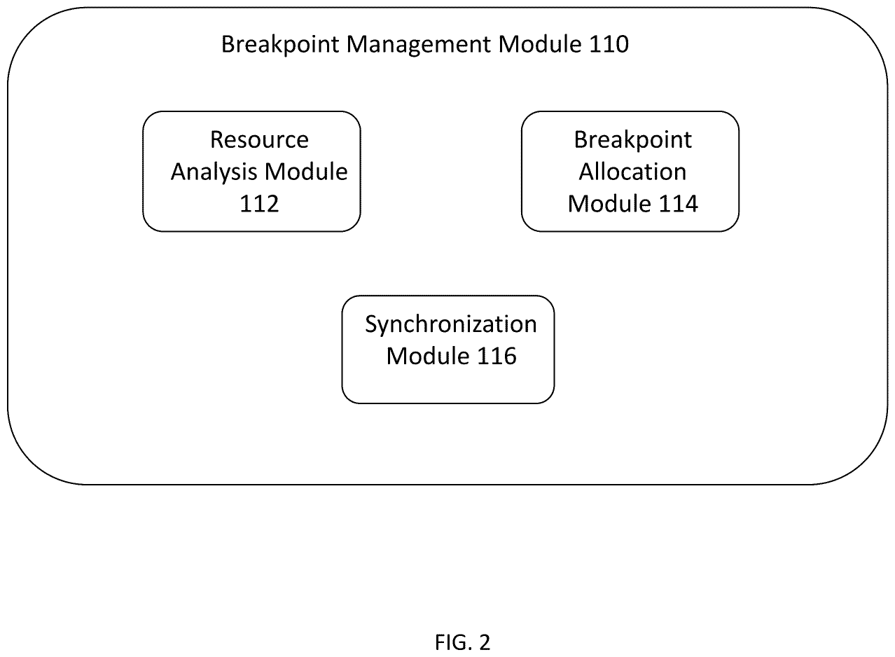

FIG. 2 is a diagram illustrating an example of an internal structure of the breakpoint management module 110, which is responsible for managing functional and line breakpoints dynamically within the cloud-based debugging system 100. As shown in FIG. 2, the breakpoint management module 110 comprises three interconnected submodules: resource analysis module 112, breakpoint allocation module 114, and synchronization module 116. These submodules collaborate to optimize the debugging process by analyzing resources, assigning breakpoints, and maintaining synchronization across distributed cloud nodes. In some embodiments, line breakpoints may be defined within a selected function breakpoint to enable finer-grained debugging of the decision logic. Line breakpoints represent specific lines of logic within a function and are managed dynamically by the breakpoint management module 110. For example, a user may set line breakpoints at key conditional statements or variable assignments within a selected function to examine the logic flow in detail. The system supports navigation commands, such as “step-over” to skip the current line of execution or “step-into” to dive into a nested function. This capability is particularly useful in debugging nested or interdependent decision logic, where the error may reside within a specific line of code.

The resource analysis module 112 evaluates the computational resources available across distributed cloud nodes. In some embodiments, this resource analysis module 112 analyzes parameters such as CPU usage, memory availability, and network bandwidth on each node to determine their suitability for hosting breakpoints. For example, if a particular node is heavily loaded with other tasks, resource analysis module 112 identifies alternative nodes that can efficiently handle additional breakpoints, ensuring balanced workload distribution. The breakpoint allocation module 114 dynamically assigns breakpoints to appropriate cloud nodes based on the analysis provided by resource analysis module 112. The breakpoint allocation module 114 uses a heuristic algorithm to distribute breakpoints based on the node's current workload and proximity to relevant data. The breakpoint allocation module 114, in some embodiments, considers factors such as the proximity of required data for decision logic, the workload of each node, and anticipated processing times. For example, when a complex decision logic flow involves multiple breakpoints, breakpoint allocation module 114 balances these breakpoints across multiple nodes to minimize latency and prevent overloading any single node.

The resource analysis module 112 facilitates the allocation and utilization of computational resources across distributed cloud nodes. The resource analysis module 112 continuously monitors real-time parameters such as CPU utilization, memory availability, network bandwidth, and disk I/O performance for each node within the distributed environment. By analyzing these metrics, the resource analysis module 112 may identify nodes with available resources capable of hosting additional computational workloads. The resource analysis module 112 uses predictive algorithms to forecast resource usage patterns based on historical data, enabling proactive reallocation of tasks to prevent bottlenecks and improve performance. For example, in scenarios involving highly complex decision logic with nested functions and interdependencies, the resource analysis module 112 dynamically evaluates the computational demands of each breakpoint and redistributes the breakpoints across nodes with sufficient capacity, reducing execution latency and avoiding node overload. Additionally, the resource analysis module 112 may integrate with the breakpoint allocation module 114 to prioritize the placement of breakpoints on nodes that are geographically closer to the data required for execution, reducing data transmission delays and improving synchronization speeds. The resource analysis module 112 may also support adaptive resource management in resource-constrained environments, where the resource analysis module 112 minimizes computational overhead by selectively disabling non-essential operations or reducing logging verbosity while maintaining debugging capabilities. Adaptive resource management is particularly beneficial when debugging large-scale decision logic in environments with limited computational resources, such as edge computing nodes or low-bandwidth networks. To support scalability, the resource analysis module 112 incorporates a multi-tiered resource evaluation framework that considers both local node conditions and global resource availability across the entire distributed system. The resource analysis module 112 balances workload distribution by dynamically reallocating breakpoints and related tasks among nodes in response to changes in resource availability or debugging demands. Furthermore, the resource analysis module 112 includes an integrated feedback mechanism that continuously reports resource utilization metrics to the visualization processing module, allowing users to monitor resource usage in real-time through intuitive dashboards. This transparency helps users make informed decisions regarding breakpoint placement and debugging priorities. The resource analysis module 112 also supports multi-tenant environments by isolating and managing resource allocation between tenants to prevent resource contention and promote fair access to computational power. By combining real-time monitoring, predictive analytics, and adaptive resource management, the resource analysis module 112 enhances debugging workflows, maintains system reliability, and delivers a seamless user experience in complex distributed cloud environments.

The synchronization module 116 maintains consistent breakpoint states across all relevant nodes within the distributed system. In some embodiments, when a breakpoint is triggered on one node, the synchronization module 116 propagates the execution state and debugging data to other nodes to aid in consistency. For instance, if a breakpoint pauses a nested function, synchronization module 116 enables the associated debugging data is updated across all visualization interfaces, including console tab 140, properties tab 150, and execution tab 160. These submodules operate collaboratively to enable dynamic and efficient breakpoint management in large-scale distributed environments. For example, when a user defines a breakpoint through interface module (not shown in the FIGs), the resource analysis module 112 assesses the available resources, the breakpoint allocation module 114 assigns the breakpoint to the most suitable node, and the synchronization module 116 updates all distributed nodes to reflect the new breakpoint. This coordinated workflow enables scalability, reliability, and consistency during debugging operations.

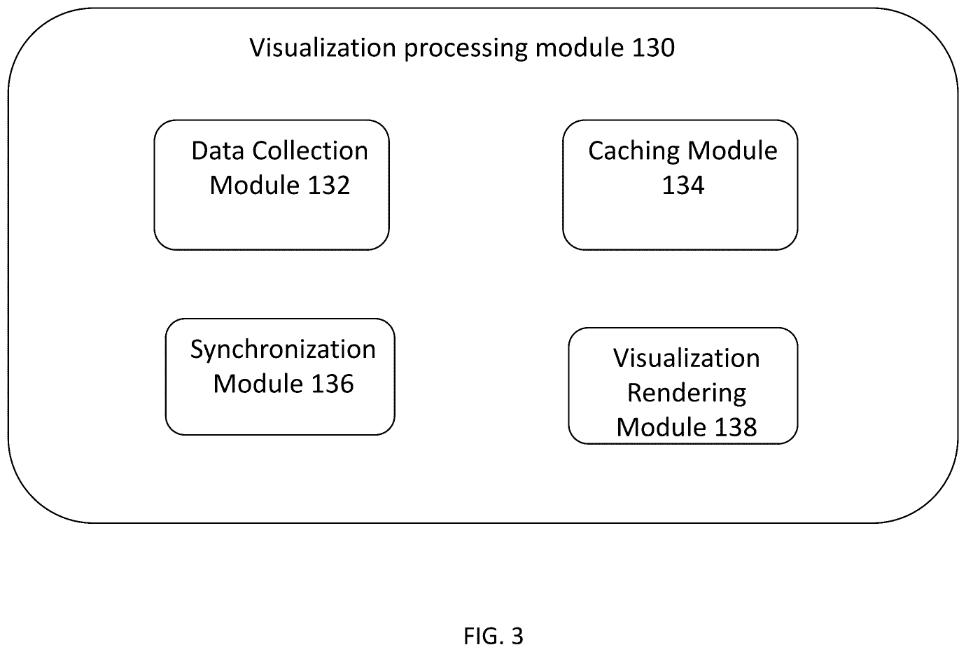

FIG. 3 is a diagram illustrating an example of an internal structure of the visualization processing module 130, which is responsible for dynamically processing and updating visual representations of debugging data within the cloud-based debugging system 100. As shown, visualization processing module 130 comprises four interconnected submodules: data collection module 132, caching module 134, synchronization module 136, and visualization rendering module 138. These submodules work collaboratively to aid in efficient and responsive visualization of debugging data across the distributed cloud environment.

Data collection module 132 is responsible for gathering debugging data from distributed cloud nodes. In some embodiments, this data collection module 132 collects data such as input parameters, global variables, and local variables from each node during the debugging process. For example, when execution pauses at a breakpoint, data collection module 132 aggregates the necessary debugging information from all relevant nodes to prepare it for further processing and visualization.

Caching module 134 manages the storage and retrieval of frequently accessed debugging data to reduce latency and minimize network traffic. In some embodiments, caching module 134 stores recent debugging data locally on each node, enabling faster access during subsequent operations. For instance, if a user revisits a previous breakpoint, caching module 134 retrieves the cached data instead of querying remote nodes, improving the responsiveness of the visualization system. Synchronization module 136 aids in consistency of debugging data across distributed nodes in the system. When data is updated on one node, synchronization module 136 propagates these updates to all relevant nodes to maintain a unified debugging state. For example, if a variable's value changes during execution, synchronization module 136 enables the updated value is reflected across all nodes and displayed accurately in properties tab 150, console tab 140, and execution tab 160. Synchronization module 136 may correspond to synchronization module 116 shown in FIG. 2, or it may function as a separate and distinct module. In some embodiments, synchronization module propagates updated states using a message-passing protocol over a distributed cache. In some embodiments, navigation commands are provided to enable users to control the flow of execution during debugging. For example, the “step-over” command allows users to execute the current line of logic without entering nested functionals, while the “step-into” command enables users to dive into the logic of a nested functional for detailed inspection. These commands are accessible through the interface module and provide flexibility in navigating complex logic. For instance, a user debugging a conditional statement can use “step-over” to skip to the next logic block or “step-into” to investigate the evaluation of a specific condition.

Synchronization module 136 aids in consistency of debugging data across distributed nodes in the system. When data is updated on one node, synchronization module 136 propagates these updates to all relevant nodes to maintain a unified debugging state. For example, if a variable's value changes during execution, synchronization module 136 enables the updated value is reflected across all nodes and displayed accurately in properties tab 150, console tab 140, and execution tab 160. Visualization rendering module 138 processes the collected and synchronized data for display in the system's visualization interfaces. In some embodiments, the visualization rendering module 138 formats debugging data for dynamic presentation in console tab 140, properties tab 150, and execution tab 160. For example, visualization rendering module 138 prioritizes and highlights critical data points, such as recently modified variables or function call stacks, ensuring users can quickly identify relevant information. The collaboration of these submodules enables visualization processing module 130 to deliver real-time, accurate, and scalable data visualization during debugging workflows. For instance, when a user pauses execution at a breakpoint, data collection module 132 gathers relevant data, caching module 134 stores it for quick access, synchronization module 136 aids in data consistency across nodes, and visualization rendering module 138 updates the corresponding visualization tabs with the latest information. This modular design enables the system can handle large-scale debugging scenarios efficiently while providing users with an intuitive and seamless debugging experience. The console tab 140 provides real-time output of print statements embedded within the decision logic, enabling users to monitor intermediate results and logic flow during execution. For example, users can insert print statements to log variable values or execution states at specific points in the logic. The console tab dynamically updates as the execution progresses, displaying results in chronological order. The execution tab 160 visualizes the execution stack, which shows the sequence of decision logic executed up to the current breakpoint. In some embodiments, the execution stack is represented as a tree structure, allowing users to trace the flow of logic from top-level functions to nested function calls. For example, users can expand or collapse nodes within the execution stack to view the details of specific logic paths. This feature provides traceability and helps identify where errors or deviations occur within the decision flow.

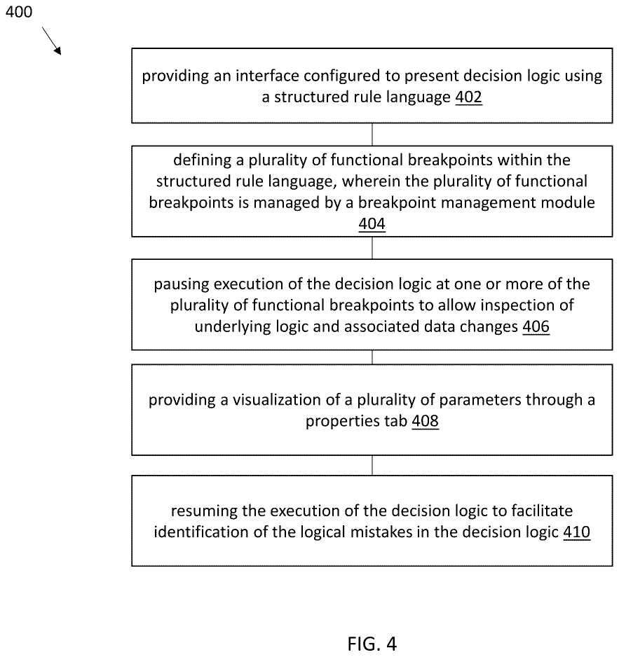

FIG. 4 is a diagram illustrating a flow chart of a process 400 for identifying logical mistakes in a cloud-based decision management system, in accordance with one or more embodiments of the current subject matter. As shown in FIG. 4, the process 400 may begin with operation 402, where the system provides an interface configured to present decision logic using a structured rule language. This interface allows users to visualize and interact with decision logic represented in various formats, such as decision tables, rulesets, or functions. In some embodiments, the interface may include tools for navigating between rules, viewing logic dependencies, and providing interactive controls for defining breakpoints. In operation 404, the system defines a plurality of functional breakpoints within the structured rule language. These functional breakpoints may represent decision nodes or specific rules within the decision logic. In some embodiments, the functional breakpoints are managed by a breakpoint management module, which is configured to optimize computational power and memory utilization across distributed cloud nodes. For example, the module may dynamically allocate breakpoints to nodes with sufficient resources to maintain debugging efficiency. The process continues with operation 406, where the system pauses the execution of decision logic at one or more of the defined functional breakpoints to allow inspection of the underlying logic and associated data changes. In some embodiments, this operation is facilitated by a distributed breakpoint execution engine that synchronizes execution states across distributed cloud nodes. For example, when a breakpoint is triggered on a specific node, the distributed execution engine enables related debugging data is collected and synchronized across all nodes to provide a unified debugging view. In operation 408, the system provides a visualization of a plurality of parameters through a properties tab. This visualization dynamically updates in real time, presenting input parameters, global variables, and local variables to the user. In some embodiments, the visualization is processed by a visualization processing module, which uses distributed caching and synchronization techniques to maintain low latency and aid in consistency across all debugging tabs. For example, the module may highlight recently updated variables or provide context-specific data based on the current execution state. In some embodiments, functional and line breakpoints are visually represented in an editor window within the structured rule language. Functional breakpoints are displayed as markers adjacent to corresponding functions or rules, while line breakpoints are displayed alongside specific lines of logic. Users can interact with these markers through intuitive actions such as clicking to add or remove breakpoints or dragging markers to reposition them. Additionally, the editor window provides advanced options, such as configuring conditional breakpoints based on variable states or grouping related breakpoints for batch management. These features streamline debugging workflows by providing precise control over breakpoint configurations. The process concludes with operation 410, where the system resumes the execution of decision logic to facilitate the identification of logical mistakes. In some embodiments, users may utilize advanced navigation commands, such as stepping-over or stepping-into, to control the debugging flow. For example, stepping-over may allow the user to skip a specific line of execution, while stepping-into may enable the user to dive deeper into nested functionals. The system supports iterative debugging workflows, allowing users to pause, inspect, and resume execution repeatedly until logical mistakes are identified and corrected. In some embodiments, functional and line breakpoints are represented visually in an editor window of the structured rule language. The editor window provides an intuitive interface where users can interact with breakpoints directly. For example, functional breakpoints may be displayed as markers adjacent to their corresponding rules or functions, while line breakpoints appear next to specific lines of logic within the function. Users can add, remove, or modify breakpoints by clicking on the markers or dragging them to different positions within the editor. The editor also provides contextual menus for advanced breakpoint configurations, such as conditional breakpoints or breakpoint groups.

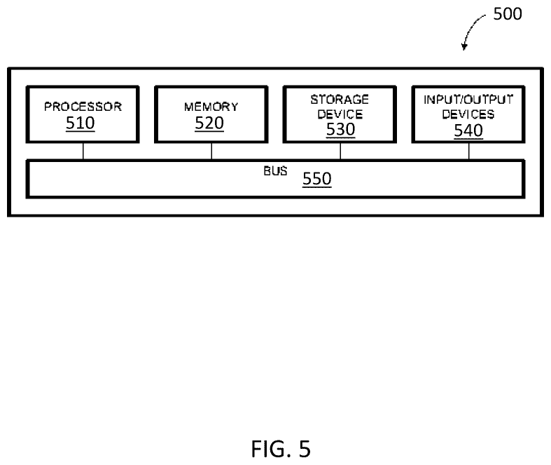

FIG. 5 depicts a block diagram illustrating a computing system 500 consistent with implementations of the current subject matter. As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The computing system 500 may additionally or alternatively include a graphic processing unit (GPU), such as for image processing, and/or an associated memory for the GPU. The GPU and/or the associated memory for the GPU may be interconnected via the system bus 550 with the processor 510, the memory 520, the storage device 530, and the input/output devices 540. The memory associated with the GPU may store one or more images described herein, and the GPU may process one or more of the images described herein. The GPU may be coupled to and/or form a part of the processor 510. The processor 510 is capable of processing instructions for execution within the computing system 500. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer-readable medium, such as volatile or non-volatile memory, that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

### Use Case

Many industries may benefit from the subject matter described herein, as it introduces advanced debugging solutions tailored for cloud-based systems, enabling efficient management of decision logic through real-time debugging, dynamic breakpoint handling, and distributed execution synchronization. For example, a healthcare organization runs a distributed cloud-based decision support system to manage patient treatment workflows. The system uses complex decision logic encoded in a structured rule language. A critical issue arises where certain patients are assigned incorrect treatment protocols due to logical errors in the rule set. Developers and system administrators need to debug and resolve the issue in real time to prevent adverse patient outcomes. A healthcare practitioner reports that the decision support system assigned incorrect treatment protocols to several patients. The system logs are reviewed, and an anomaly in a specific decision rule for calculating medication dosage is identified. The developer opens the system's debugging interface, which presents decision logic in a structured rule language. The specific rule node responsible for dosage calculation is identified, and the developer sets a functional breakpoint at the decision node for medication dosage. Line breakpoints are added within the dosage rule to inspect specific conditional statements and variable assignments. The breakpoint management module dynamically allocates the breakpoints to appropriate cloud nodes based on resource availability. The distributed execution engine pauses the execution when the breakpoint is triggered for a real-time patient data input. Debugging data, including input parameters and intermediary variable values, is synchronized across nodes and displayed in the developer's interface. The developer observes the properties tab to review the current values of input parameters, such as patient weight, age, and allergies, and identifies an inconsistency in the logic for handling patient allergies. The developer corrects the logical condition in the rule language editor and uses step-over and step-into commands to simulate and navigate through the updated logic. The correction is validated by checking the execution stack in the execution tab and comparing output against expected results. The system administrator reviews the system resource impact during debugging to ensure no degradation of live services. After approval, the updated rule logic is deployed to the production environment. The healthcare practitioner runs test cases for patient records where errors occurred previously and confirms that the system now assigns correct treatment protocols. The logical error in the rule set is resolved, and the system resumes normal operation with updated and validated rules. Debugging data and logs are archived for future reference and compliance. This use case demonstrates how the Breakpoint Management and Execution Engine enhances the debugging process in a critical healthcare application, ensuring patient safety and system reliability. It provides real-time debugging, precise targeting of errors through dynamic breakpoint management, distributed synchronization, and user-friendly visualization tools while maintaining minimal service disruption during the debugging process.

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for identifying logical mistakes in a cloud-based decision management system, comprising:
providing an interface configured to present decision logic using a structured rule language;
defining a plurality of functional breakpoints within the structured rule language, wherein the plurality of functional breakpoints is managed by a breakpoint management module configured to optimize computational power and memory utilization across distributed cloud nodes of the cloud-based decision management system;
pausing execution of the decision logic at one or more of the plurality of functional breakpoints to allow inspection of underlying logic and associated data changes, wherein the pausing and synchronization are facilitated by a breakpoint execution engine operating within the cloud-based decision management system;
providing a visualization of a plurality of parameters through a properties tab, wherein the visualization is dynamically processed in real-time by a visualization processing module using distributed caching and synchronization of the cloud-based decision management system, wherein the visualization processing module collaborates with the breakpoint management module to optimize computational power by selectively updating parameters that are relevant to the functional breakpoint, and dynamically allocating lightweight cloud nodes for visualization tasks; and
resuming the execution of the decision logic to facilitate identification of the logical mistakes in the decision logic, wherein the visualization provides real-time updates and aids in pinpointing logical mistakes, and wherein the breakpoint management module deploys one or more of the plurality of functional breakpoints based at least in part on computational resource.

2. The method of claim 1, wherein the method further comprising:
enabling a user to define one or more line breakpoints within a selected function breakpoint; and
allowing the user to navigate the decision logic by stepping over or stepping into individual lines or nested functionals using one or more navigation commands associated with the one or more line breakpoints.

3. The method of claim 2, wherein the navigation commands comprise a first command to execute the logic one line at a time without entering nested functionals; and a second command to enter the logic of a nested functional.

4. The method of claim 2, wherein the functional breakpoints and line breakpoints are represented visually in an editor window of the structured rule language to allow the user to interactively select, modify, or remove breakpoints.

5. The method of claim 1, wherein the properties tab comprises: i) a parameters node configured to display values of input parameters; ii) a global variables node configured to display values of global variables, and iii) a local variables node configured to display values of local variables.

6. The method of claim 1, further comprising providing a console tab that displays results of print statements embedded in the structured rule language, wherein the displayed results are updated as the execution progresses.

7. The method of claim 1, further comprising displaying an execution stack in an execution tab, wherein the execution stack shows a sequence of decision logic stacks executed up to current breakpoint to provide traceability in a flow of decision logic.

8. A computer program product, for identifying logical mistakes in a cloud-based decision management system, comprising a non-transient machine-readable medium storing instructions that, when executed by at least one programmable processor, cause the at least one programmable processor to perform operations comprising:
providing an interface configured to present decision logic using a structured rule language;
defining a plurality of functional breakpoints within the structured rule language, wherein the plurality of functional breakpoints is managed by a breakpoint management module configured to optimize computational power and memory utilization across distributed cloud nodes of the cloud-based decision management system;
pausing execution of the decision logic at one or more of the plurality of functional breakpoints to allow inspection of underlying logic and associated data changes, wherein the pausing and synchronization are facilitated by a breakpoint execution engine operating within the cloud-based decision management system;
providing a visualization of a plurality of parameters through a properties tab, wherein the visualization is dynamically processed in real-time by a visualization processing module using distributed caching and synchronization of the cloud-based decision management system, wherein the visualization processing module collaborates with the breakpoint management module to optimize computational power by selectively updating parameters that are relevant to the functional breakpoint, and dynamically allocating lightweight cloud nodes for visualization tasks; and
resuming the execution of the decision logic to facilitate identification of the logical mistakes in the decision logic, wherein the visualization provides real-time updates and aids in pinpointing logical mistakes, and wherein the breakpoint management module deploys one or more of the plurality of functional breakpoints based at least in part on computational resource.

9. The computer program product of claim 8, wherein the operations further comprise:
enabling a user to define one or more line breakpoints within a selected function breakpoint; and
allowing the user to navigate the decision logic by stepping over or stepping into individual lines or nested functionals using one or more navigation commands associated with the one or more line breakpoints.

10. The computer program product of claim 9, wherein the navigation commands comprise a first command to execute the logic one line at a time without entering nested functionals; and a second command to enter the logic of a nested functional.

11. The computer program product of claim 9, wherein the functional breakpoints and line breakpoints are represented visually in an editor window of the structured rule language to allow the user to interactively select, modify, or remove breakpoints.

12. The computer program product of claim 8, wherein the properties tab comprises: i) a parameters node configured to display values of input parameters; ii) a global variables node configured to display values of global variables, and iii) a local variables node configured to display values of local variables.

13. The computer program product of claim 8, wherein the operations further comprise providing a console tab that displays results of print statements embedded in the structured rule language, wherein the displayed results are updated as the execution progresses.

14. The computer program product of claim 8, wherein the operations further comprise displaying an execution stack in an execution tab, wherein the execution stack shows a sequence of decision logic stacks executed up to current breakpoint to provide traceability in a flow of decision logic.

15. A system, for identifying logical mistakes in a cloud-based decision management system, comprising:
at least one programmable processor; and
a non-transient machine-readable medium storing instructions that, when executed by the processor, cause the at least one programmable processor to perform operations comprising:
providing an interface configured to present decision logic using a structured rule language;
defining a plurality of functional breakpoints within the structured rule language, wherein the plurality of functional breakpoints is managed by a breakpoint management module configured to optimize computational power and memory utilization across distributed cloud nodes of the cloud-based decision management system;
pausing execution of the decision logic at one or more of the plurality of functional breakpoints to allow inspection of underlying logic and associated data changes, wherein the pausing and synchronization are facilitated by a breakpoint execution engine operating within the cloud-based decision management system;
providing a visualization of a plurality of parameters through a properties tab, wherein the visualization is dynamically processed in real-time by a visualization processing module using distributed caching and synchronization of the cloud-based decision management system, wherein the visualization processing module collaborates with the breakpoint management module to optimize computational power by selectively updating parameters that are relevant to the functional breakpoint, and dynamically allocating lightweight cloud nodes for visualization tasks; and
resuming the execution of the decision logic to facilitate identification of the logical mistakes in the decision logic, wherein the visualization provides real-time updates and aids in pinpointing logical mistakes, and wherein the breakpoint management module deploys one or more of the plurality of functional breakpoints based at least in part on computational resource.

16. The system of claim 15, wherein the operations further comprise:
enabling a user to define one or more line breakpoints within a selected function breakpoint; and
allowing the user to navigate the decision logic by stepping over or stepping into individual lines or nested functionals using one or more navigation commands associated with the one or more line breakpoints.

17. The system of claim 16, wherein the navigation commands comprise a first command to execute the logic one line at a time without entering nested functionals; and a second command to enter the logic of a nested functional.

18. The system of claim 16, wherein the functional breakpoints and line breakpoints are represented visually in an editor window of the structured rule language to allow the user to interactively select, modify, or remove breakpoints.

19. The system of claim 15, wherein the properties tab comprises: i) a parameters node configured to display values of input parameters; ii) a global variables node configured to display values of global variables, and iii) a local variables node configured to display values of local variables.

20. The system of claim 15, wherein the operations further comprise providing a console tab that displays results of print statements embedded in the structured rule language, wherein the displayed results are updated as the execution progresses.
